(19) United States
(12) Patent Application Publication
(10) Pub. No.: US 2026/0003721 A1
(43) Pub. Date: Jan. 1, 2026

(54) METHODS AND SYSTEMS FOR REPORTING PROBABLE CAUSES OF ERRORS IN SERVICES

(71) Applicant: Hewlett Packard Enterprise Development LP, Spring, TX (US)

(72) Inventors: Thavamani Raja Sakthivel, Bangalore, Karnataka (IN); Gavin Brebner, St. Martin D'Uriage (FR); Neeraj Kumar, Bangalore, Karnataka (IN)

(21) Appl. No.: 18/790,511

(22) Filed: Jul. 31, 2024

(30) Foreign Application Priority Data
Jun. 28, 2024 (EP) 24306050.6

(51) Int. Cl. G06F 11/07

(52) U.S. Cl. CPC G06F 11/079; G06F 11/0709

(57) ABSTRACT

Examples described herein relate to a method and a network analyzer configured to report a probable cause of errors in a microservice environment. In some examples, the network analyzer may identify an impacted service that reported an error. Further, the network analyzer identifies one or more upstream services related to the impacted service based on a service dependency between the one or more upstream services and the impacted service. Furthermore, the network analyzer identifies at least one modification in one or more of the impacted service or the one or more upstream services based on respective versions of the impacted service and the one or more upstream services, then reports a set of candidate modifications selected from the at least one modification as probable causes of the error.

### BACKGROUND

In modern cloud deployments, monolithic services wherein several processes are tightly coupled and run as a single service are modernized into individual microservices that can adopt computing responsibilities. Microservices are a cloud-native architectural approach in which a single application comprises many loosely coupled and independently deployable smaller components, or services. Accordingly, microservices are simpler, and more cost-effective as application components are decoupled and no longer bundled. In certain deployments, a cloud-hosted application comprises several small services that communicate with each other using Application Programming Interfaces (APIs). In particular, microservices may be deployed as autonomous components and can be developed, deployed, operated, and/or scaled independently without affecting other services. In some cases, each microservice may be designed for specific capabilities, focusing on solving a particular problem.

In some implementations, the microservices may reference and/or use objects (e.g., program code, libraries, syntaxes, outputs) from one or more other microservices. As will be understood, any changes in more microservices may impact the performance of the other microservices.

### BRIEF DESCRIPTION OF THE DRAWINGS

Features, aspects, and advantages of the present specification will become better understood when the following detailed description is read with reference to the accompanying drawings in which like characters represent like parts throughout the drawings.

FIG. 1 depicts a system in which various examples presented herein may be implemented.

FIG. 2 depicts an example service dependency tree illustrating inter-service dependencies.

FIG. 3 depicts a block diagram of an example network analyzer.

FIG. 4 depicts a flow diagram of an example high-level method for reporting root causes for an error encountered by a service.

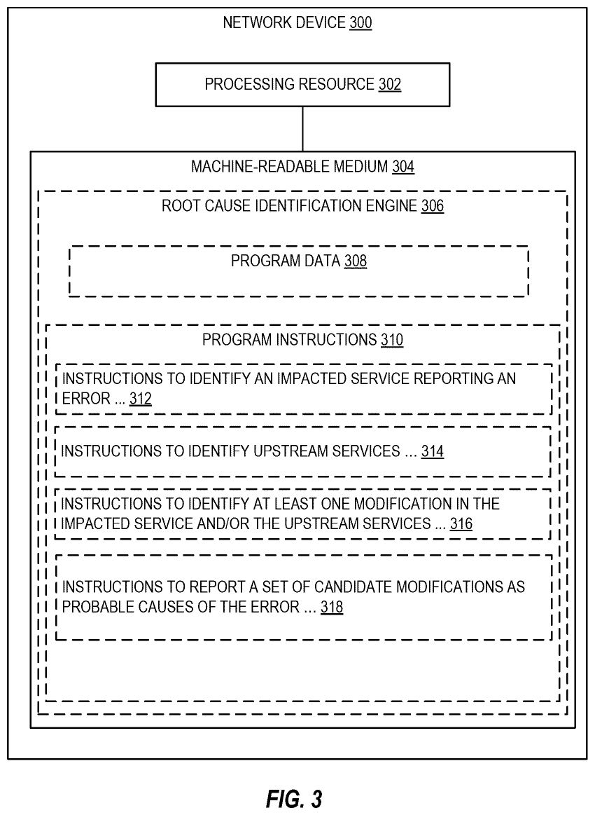

FIG. 3 depicts a flow diagram of another example method for reporting a set of candidate modifications as a root cause for an error encountered by a service.

It is emphasized that, in the drawings, various features are not drawn to scale. In fact, in the drawings, the dimensions of the various features have been arbitrarily increased or reduced for clarity of discussion.

### DETAILED DESCRIPTION

To ensure that each microservice's functionality and performance are stable and its failure does not affect the entire software system or an application using such microservices, the microservices are evaluated before deploying the microservices into a production environment. In particular, the microservices are evaluated independently before integrating them into an application and also to verify that all microservices work seamlessly together in the application. The testing of the microservices entails performing several tests considering their isolated nature and dependencies.

In some cases, despite the testing, when any modifications are made in one or more of the microservices and the application that uses such microservices is executing in the production environment, there may be a risk of disrupting the application's functionality. The modification may be of any kind, such as, a code change, a configuration change, a hardware change, an operating environment change, or combinations thereof. In some cases, the problem caused by such modifications may be obvious, for instance, a key component of the application no longer works. In other situations, the modifications may create intermittent issues that affect only certain customers. In such cases, a classic debug approach for a previously stable application may entail receiving incidents via tools such as PagerDuty or similar, observing error information in logs, and then deducing that the issues are likely to be due to any changes that happened shortly before the issues were reported. However, increasingly software systems are made up of highly distributed sets of microservices, maintained by different teams, and whose deployments to the production environment may not be coordinated or communicated in any clear manner. While contract testing and other approaches can minimize the impact of changes in the other services, disruptions may still occur. Key metrics such as Service Level Indicators (SLIs) that track the user experience can provide important data, in particular, on how an error budget is being consumed. For instance, a noticeable increase in the error budget consumption may be a key indicator that something is wrong with the application. This is generally adapted to track a type of intermittent issue caused by subtle inter-service compatibility issues.

Traditionally, information from logs and incident reporting is used to identify when things may go wrong for a particular microservice. Further, certain version control tools, for example, GitHub provide time stamps for when changes were made. Also, certain tools such as continuous integration and continuous delivery/deployment systems may aid in tracking changes made to applications in the production environment. Furthermore, some known solutions entail monitoring of certain metrics that may be used to measure the reliability of microservices, however, tracking a probable source of reliability issues that originate in other services remains a challenge causing delays in addressing the issues.

In examples consistent with the teachings of this disclosure, presented are a method and a system, for example, a network analyzer, which may aid in narrowing down the source of issues seen in microservices by combining log and incident data with data on the dependencies between microservices. The terms ‘microservice’ and ‘service’ are used interchangeably in the description hereinafter. In particular, the proposed network analyzer uses intelligence about the interdependency of services to determine likely sources of problems in complex applications that are built using services.

In some examples, the proposed network analyzer may be configured to store a service dependency database that maintains information representing relationships between a plurality of services. The relationships between the plurality of services may indicate which service makes use of which other services. In particular, the service dependency database is configured with the information on inter-service dependencies either manually or based on automated scanning of code repositories for data on dependencies. In some cases, the network analyzer may capture the inter-service dependencies during the deployment of the services. The network analyzer may use such inter-service dependencies to identify which upstream services are causing issues in a given service. Also, in some examples, the network analyzer may maintain, for each service, a link to version control information indicating a stream of change requests (i.e., modifications).

As such, the inter-service dependencies may be visualized as a directed graph showing the relationships between services. The proposed technique of identifying probable sources of issues in the microservices relies on the fact that modifications in a service that is far away from a given service (i.e., having an increased number of hops from the given service) may have a lower probability of causing issues in the given service compared the service that is closer to the given service (i.e., having a decreased number of hops from the given service).

In accordance with the examples presented herein, the network analyzer is configured to identify an impacted service reporting an error. In particular, the network analyzer may use information from incident logs, error logs, and/or device health logs to identify the problem and the service (referred to as the impacted service) that reports the problem. Further, the network analyzer may identify one or more upstream services related to the impacted service based on the inter-service dependencies. In particular, for a given service, the upstream services may refer to services from which the given service may receive data and/or services that the impacted service references during its execution.

Furthermore, the network analyzer may identify at least one modification in one or more of the impacted service or the one or more upstream services based on respective versions of the impacted service and the one or more upstream services. Then, the network analyzer may select a set of candidate modifications from the at least one modification based on respective timestamps. In particular, the network analyzer may apply time-based filtering to discard certain old modifications as the newest modifications may have a more recent impact on the services. Thereafter, the network analyzer may report the set of candidate modifications as probable causes of the problem. As will be appreciated, the identification of the probable causes of the problem may help in addressing the problem by making relevant corrections to the services, thereby improving service reliability and the customer experience. Further, the automated identification of the probable causes provides pointers to the changeset to the developer. This significantly reduces the mean time to repair (MTRR) services while minimizing the breach of service level objectives.

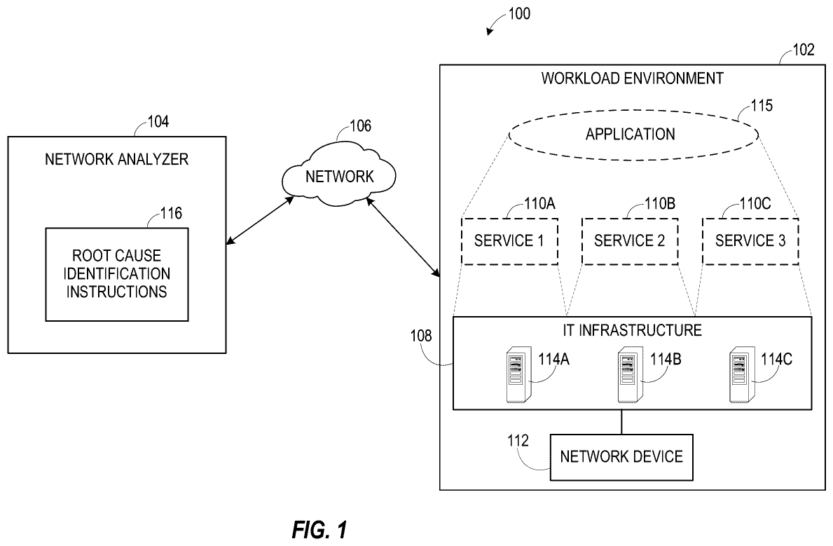

Referring now to the drawings, in FIG. 1, an example system 100 is presented. The system 100 may include a workload environment 102 and a network analyzer 104. In some examples, the network analyzer 104 may be located outside of the workload environment 102 and communicate with the workload environment 102 via a network 106, as depicted in FIG. 1. However, the scope of the present disclosure should not be limited to the implementation depicted in FIG. 1. In certain examples, the network analyzer 104 may be deployed within the workload environment 102. The workload environment 102 may be an on-premises network infrastructure of an entity (e.g., an individual or an organization or enterprise), a private cloud network, a public cloud network, or a hybrid public-private cloud network.

In some examples, the workload environment 102 may include an information technology (IT) infrastructure 108 hosting one or more services, such as services 110A, 110B, and 110C (hereinafter collectively referred to as services 110A-110C). The IT infrastructure 108 and the services 110A-110C may be accessible via a networking device 112. Also, the IT infrastructure 108 and the services 110A-110C may communicate with any system or device outside the workload environment 102 via the networking device 112.

The IT infrastructure 108 may be a network of IT resources hosted in the workload environment 102. In one example, the IT infrastructure 108 may be a datacenter hosted at the workload environment 102. Examples of the IT resources hosted in the IT infrastructure 108 may include, but are not limited to, servers, storage devices, desktop computers, and portable computers. The servers may be blade servers, for example. The storage devices may be storage blades, storage disks, or storage enclosures, for example. For illustration purposes, the IT infrastructure 108 is shown to include a plurality of servers 114A, 114B, and 114C (hereinafter collectively referred to as servers 114A-114C). It is to be noted that the scope of the present disclosure is not limited with respect to the count or type of IT resources deployed in the IT infrastructure 108. For example, although three servers 114A-114C are depicted in FIG. 1, the use of any different number of servers is also envisioned within the purview of the present disclosure. One or more of the IT resources (e.g., the servers 114A-114C) may allow operating systems, applications, and/or application management platforms (e.g., workload hosting platforms-such as, a hypervisor, a container runtime, a container orchestration system, and the like) to run thereon.

In some examples, the services 110A-110C may be hosted on one or more of the IT resources (e.g., the servers 114A-114C). The term, “service” or “microservice” as used herein may refer to an individual software (built using program code executable by a processor) that may facilitate one or more functionalities or features in an application 115. The application 115 may be a software tool that may use and/or integrate, along with any additional program code, one or more of the services 110A-110C for accomplishing one or more tasks/features. The services 110A-110C may be executed directly via the operating systems running on the IT resources or via virtual environments running on the IT resources. Examples of the virtual environments may include, but are not limited to, virtual machines, containers, pods, or the like. The services 110A-110C may be referenced or used by one or more applications, for example, the application 115, to accomplish intended tasks or execute respective features of the respective application. By way of example, the application 115 (e.g., a mobile banking application) may use the service 110A to open a new account task, and the service 110B to manage payments.

The networking device 112 may be a network communication device acting as a point of access to the IT infrastructure 108 and the services 110A-110C hosted on the IT infrastructure 108. Any data traffic directed to the IT infrastructure 108 and the services 110A-110C may flow to the IT infrastructure 108 and the services 110A-110C via the networking device 112. In some examples, each of the servers 114A-114C may be physically (e.g., via wires) or wirelessly connected to the networking device 112. In particular, in some examples, the networking device 112, may be in communication with the network 106, directly or via intermediate communication devices (e.g., a router or an access point). In one example, the networking device 112 may be a network switch (physical or logical). In some examples, the networking device 112 may interconnect the servers 114A-114C in the IT infrastructure 108 using packet-switching techniques to enable data communication therebetween and with any other device (e.g., a router or an access point) connected to the networking device 112.

Communication between the network analyzer 104 (described later) and the workload environment 102 may be facilitated via the network 106. Examples of the network 106 may include, but are not limited to, an Internet Protocol (IP) or non-IP-based local area network (LAN), a wireless LAN (WLAN), a metropolitan area network (MAN), wide area network (WAN), a storage area network (SAN), a personal area network (PAN), a cellular communication network, a Public Switched Telephone Network (PSTN), and the Internet. In some examples, the network 106 may include one or more network switches, routers, or network gateways to facilitate data communication. In some examples, the network device 122 may be part of the network 106. Communication over the network 106 may be performed per various communication protocols such as, but not limited to, Transmission Control Protocol and Internet Protocol (TCP/IP), User Datagram Protocol (UDP), IEEE 802.11, and/or cellular communication protocols. The communication over the network 106 may be enabled via wired (e.g., copper, optical communication, etc.) or wireless (e.g., Wi-Fi®, cellular communication, satellite communication, Bluetooth, etc.) communication technologies. In some examples, the network 106 may be enabled via private communication links including, but not limited to, communication links established via Bluetooth, cellular communication, optical communication, radio frequency communication, wired (e.g., copper), and the like. In some examples, the private communication links may be direct communication links between the network analyzer 104 and the workload environment 102.

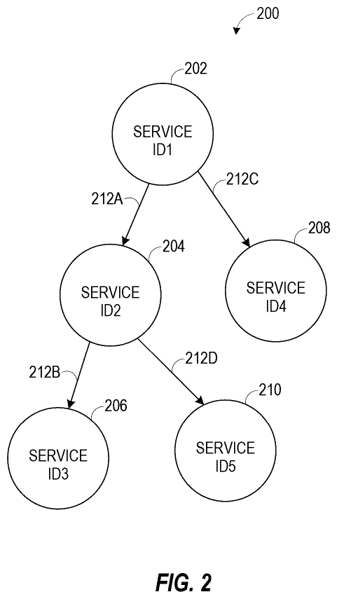

Referring back to the services 110A-110C, it may be noted that the services 110A-110C may depend on one another, i.e., the services may reference each other. In one example, the execution of one service may entail executing another service. In another example, one service may use the output of another service to generate a particular result. In certain examples, one service may function as a library of program codes, variables, and data that other services may use. FIG. 2 depicts an example representation in the form of a service dependency tree 200 illustrating the interdependencies of services. For ease of illustration, FIG. 2 is described concurrently with FIG. 1. In particular, as shown in FIG. 2, the service dependency tree 200 depicts interdependencies among five services-services 202, 204, 206, 208, and 210 (hereinafter collectively referred to as services 202-210). The services 202-210 may be representatives of the services 110A-110C of FIG. 1. Although the interdependencies among five services are depicted in FIG. 2, it may be understood that interdependencies among any number of services may be represented in the form of such service dependency tree. Such interdependency may be due to any of the reasons stated above.

In particular, as depicted in the service dependency tree 200, the services 202-210 may be identified by respective unique identifiers, also called unique service identifiers. For example, the unique service identifiers of the services 202, 204, 206, 208, and 210 are “SERVICE ID1,” “SERVICE ID2,” “SERVICE ID3,” “SERVICE ID4,” and “SERVICE ID5,” respectively. It is to be noted that the unique service identifiers may be represented using numbers, alphabets, operators, symbols, or combinations thereof.

During operation, any of the services 202-210 may encounter a problem or an issue causing the service to generate an error. As will be understood, the issues encountered by the service may impact the operation of applications (e.g., the application 115) that use such services 202-210. In the description hereinafter, a service that has encountered the error is referred to as an “impacted service.”

As depicted in FIG. 2, the services 204 and 208 depend directly on the service 202, whereas the services 206 and 210 depend directly on service the service 204, but depend indirectly on service 202. Therefore, for the services 206 and 210, the services 204 and 202 may qualify as upstream services. Also, for the services 204, 206, 208, and 210, the service 202 qualifies as an upstream service. Further, in the service dependency tree 200, the relationship between the two services is represented using an arrow connecting the two services, also referred to as relationship links. Table 1 presented below lists the services and respective relationship links.

TABLE 1
Example services and respective relationship links

| | SERVICE ID OF AN | RELATIONSHIP |
|---|---|---|
| SERVICE ID | UPSTREAM SERVICE | LINK |
| SERVICE ID1 | | |
| SERVICE ID2 | SERVICE ID1 | 212A |
| SERVICE ID3 | SERVICE ID2 | 212B |
| SERVICE ID4 | SERVICE ID1 | 212C |
| SERVICE ID5 | SERVICE ID2 | 212D |

In some cases, as the service is an upstream service for the rest of the services, the modifications made to the service 202 may impact the downstream services 204, 206, 208, and 210. Further, any modification to the service 204 may impact its downstream services 206 and 210. However, the magnitude of an impact that a modification in a given upstream service can cause for the impacted service may depend on a relationship distance between the target service and the given upstream service. In one example, the term “relationship distance” between two services may refer to a count of hops or a count of relationship links between the two services. In some other examples, the network analyzer 104 may assign weights to the each of the relationship links (e.g., the links 212A-212D) between the services and use such weights to identify the set of candidate modifications as the probable causes of the error in the impacted service. In particular, the proposed technique of identifying probable sources of the error in the impacted service relies on the fact that modifications in a service that is far away from the impacted service (i.e., having a greater count of relationship links/hops) may have a lower probability of causing issues in the impacted service compared the service that is closer to the impacted service (i.e., having a fewer relationship links/hops). Additional details on using the weights assigned to the relationship links are described in conjunction with FIG. 5.

Turning back to FIG. 1, in a similar fashion as described in conjunction with FIG. 2, the services 110A-110C shown in FIG. 1 may be interdependent. Accordingly, when any modification (e.g., a code change, a configuration change, a hardware change, an operating environment change, or combinations thereof) is made in one or more of the services 110A-110C, and the application 115 that uses such services is executing in the production environment, one or more services may encounter errors and the functionality of the application 115 may be impacted.

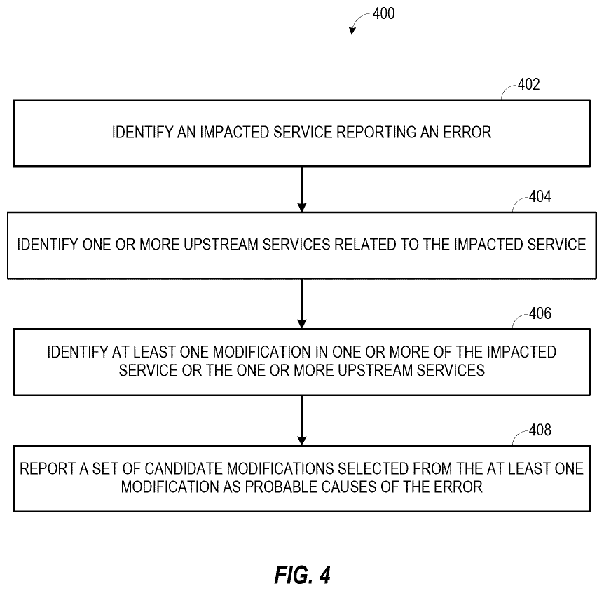

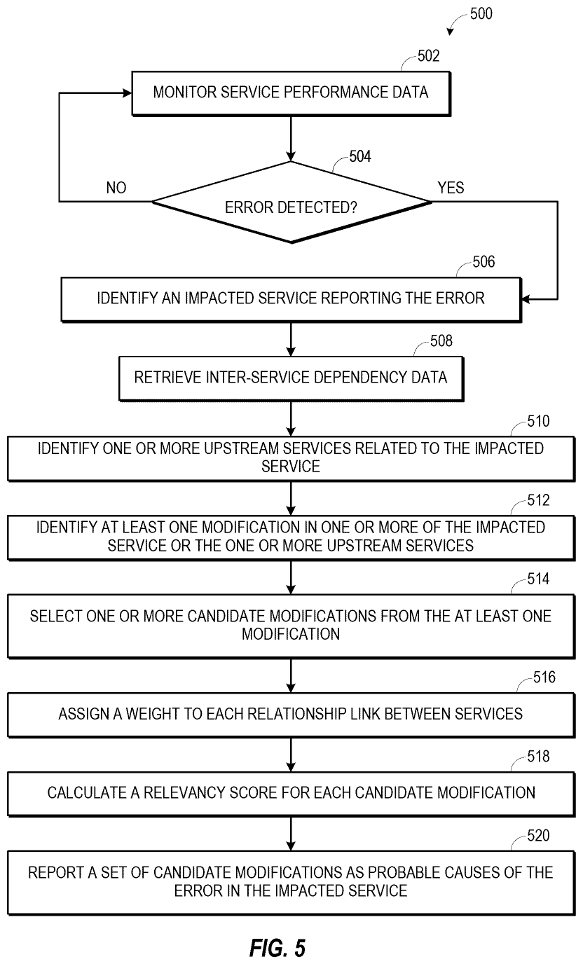

In examples consistent with the teachings of this disclosure, the network analyzer 104 may aid in identifying the probable source of errors caused in the impacted services by combining log and incident data with data on the dependencies between microservices. In particular, the proposed network analyzer 104 uses intelligence about the interdependency of services (e.g., the relationship distance) to determine likely sources of the errors caused in the impacted services. To aid in such functionalities performed by the network analyzer 104, in some examples, the network analyzer 104 may execute root cause identification instructions 116 stored in the network analyzer 104. In particular, the network analyzer 104 may include a processing resource (not shown in FIG. 1), e.g., a physical processor capable of executing program instructions, such as the instructions 116. By way of executing the root cause identification instructions 116, the network analyzer 104 may identify what modifications made in the services could have caused the error in an impacted service. In particular, by executing the root cause identification instructions 116, the network analyzer 104 may perform the methods described in FIGS. 4 and 5. Additional details of the operations performed by the network analyzer 104 are described in conjunction with FIGS. 3-5.

Referring now to FIG. 3, a block diagram of an example network analyzer 300 is presented. The network analyzer 300 of FIG. 3 may be an example representative of the network analyzer 104 of FIG. 1. In certain examples, the network analyzer 300 may be an example representative of the network device 112 of FIG. 1. In some other examples, any network device, such as, a network switch, router, and/or wireless LAN controller, may be configured to function as the network analyzer 300. Alternatively, in some implementations, the network analyzer 300 may be a computer system in a cloud infrastructure. In particular, the network analyzer 300 may be configured to identify one or more modifications that have impacted a service.

The network analyzer 300 may include a processing resource 302 and/or a machine-readable storage medium 304 for the network analyzer 300 to execute several operations as will be described in the greater details below. More particularly, the network analyzer 300 implements a root cause identification engine 306 to identify one or more modifications made in one or more services that may have caused an error in a service. problem in an application using such services. For illustration purposes, the root cause identification engine 306 and items inside the root cause identification engine 306 are represented by the dashed outline as they represent digital entities which may be in the form of data and/or instructions that are executable by a physical processing resource, for example, the processing resource 302.

The processing resource 302 may be a physical device, for example, a central processing unit (CPU), a microprocessor, a graphics processing unit (GPU), a field-programmable gate array (FPGA), application-specific integrated circuit (ASIC), other hardware devices capable of retrieving and executing instructions stored in the machine-readable storage medium 304, or combinations thereof. In one example, the processing resource 302 may fetch, decode, and execute the instructions stored in the machine-readable storage medium 304 to identify root causes for an error encountered in an impacted service. As an alternative or in addition to executing the instructions, the processing resource 302 may include at least one integrated circuit (IC), control logic, electronic circuits, or combinations thereof that include several electronic components for performing the functionalities intended to be performed by the network analyzer 300.

The machine-readable storage medium 304 may be non-transitory and is alternatively referred to as a non-transitory machine-readable storage medium that does not encompass transitory propagating signals. The machine-readable storage medium 304 may be any electronic, magnetic, optical, or another type of storage device that may store data and/or executable instructions. Examples of the machine-readable storage medium 304 may include RAM, NVRAM, EEPROM, a storage drive (e.g., SSD or HDD), a flash memory, and the like. The machine-readable storage medium 304 may be encoded with the root cause identification engine 306 which aids in identifying root causes for an error encountered in an impacted service. The root cause identification engine 306 includes program data 308 and program instructions 310 which the processing resource 302 uses to identify root causes for an error encountered in an impacted service. The program instructions 310 may be an example representative of the root cause identification instructions 116 of FIG. 1.

The program data 308 may store a variety of data that may be received, used, and/or generated by the processing resource 302 as the processing resource 302 executes the program instructions 310. By way of example, the processing resource 302 may maintain, in the program data 308, a service dependency database that maintains information representing relationships (i.e., the inter-service dependencies) between the services (e.g., the services 110A-110C, 202-210). In particular, in some examples, such a service dependency database is generated based on information on inter-service dependencies entered manually. In some other examples, the processing resource 302 may be configured to scan code repositories of the services to identify data on dependencies among the services and generate the service dependency database based on such scanning. In some cases, the processing resource 302 may be configured to capture the inter-service dependencies among the services during the deployment of the services in a workload environment (e.g., the workload environment 102). As such, the inter-service dependencies may be visualized as a directed graph or tree (see FIG. 2, for example) showing the relationships between services. Table 2 represented below depicts an example information that may be stored in the service dependency database, and using which the service dependency tree 200 of FIG. 2 may be visualized.

TABLE 2
Example service dependency database

| | SERVICE ID OF AN |
|---|---|
| SERVICE ID | UPSTREAM SERVICE |
| SERVICE ID1 | |
| SERVICE ID2 | SERVICE ID1 |
| SERVICE ID3 | SERVICE ID2 |
| SERVICE ID4 | SERVICE ID1 |
| SERVICE ID5 | SERVICE ID2 |

Additionally, in some examples, the processing resource 302 stores, for each service, a version control log comprising a link to version control information indicating a stream of change requests (i.e., modifications) in the program data 308. Also, in some examples, the processing resource 302 stores, in the program data 308, incident and error logs storing information about errors caused by any services.

In accordance with examples consistent with the present disclosure, the network analyzer 300 may execute the root cause identification engine 306, by way of the processing resource 302 executing the program instructions 310, to identify one or more modifications in services that may have caused an error in an impacted service. In particular, in some examples, the processing resource 302 may execute one or more of the program instructions 310 to perform the method steps described in conjunction with FIGS. 4 and 5. For example, the program instructions 310 may include instructions 312, 314, 316, and 318. In particular, the instructions 312 when executed by the processing resource 302 may cause the processing resource 302 to identify an impacted service reporting an error. Further, the instructions 314 when executed by the processing resource 302 may cause the processing resource 302 to identify one or more upstream services related to the impacted service based on a service dependency between the one or more upstream services and the impacted service. Furthermore, the instructions 316 when executed by the processing resource 302 may cause the processing resource 302 to identify at least one modification in one or more of the impacted service or the one or more upstream services based on respective versions of the impacted service and the one or more upstream services. Moreover, the instructions 316 when executed by the processing resource 302 may cause the processing resource 302 to report a set of candidate modifications selected from the at least one modification as probable causes of the error.

As will be appreciated, the identification of the probable causes of the error helps address any underlying problem by making relevant corrections to the services (e.g., the impacted service and the one or more upstream services), thereby improving service reliability and the customer experience. Further, the automated identification of the probable causes provides pointers to the changeset to the developer. This significantly reduces the mean time to repair (MTRR) services while minimizing the breach of service level objectives.

Although not shown, in some examples, the machine-readable storage medium 304 may be encoded with certain additional executable instructions to perform any other operations performed by the network analyzer 300, without limiting the scope of the present disclosure.

In the description hereinafter, various operations performed by a suitable device are described with the help of flowcharts depicted in FIGS. 4 and 5. In particular, FIGS. 4 and 5 depict flowcharts of example methods for identifying one or more modifications in services that may have caused an error in an impacted service. For illustration purposes, the steps shown in FIGS. 4 and 5 are described as being performed by a suitable device such as a network analyzer (e.g., the network analyzer 104 or the network analyzer 300). In some examples, the suitable device may include a processing resource (e.g., the processing resource 302) suitable for the retrieval and execution of instructions stored in a machine-readable storage medium (e.g., the machine-readable storage medium 304) to execute the methods of FIGS. 4 and 5. As an alternative or in addition to retrieving and executing instructions, the processing resource may include one or more electronic circuits that include electronic components for performing the functionality of one or more instructions, such as an FPGA, ASIC, or other electronic circuits.

Further, the flowcharts that are shown in FIGS. 4 and 5 include several steps in a particular order. However, the order of steps shown in the respective flowcharts should not be construed as the only order for the steps. The steps may be performed at any time, in any order. Additionally, the steps may be repeated, rearranged, or omitted as needed.

Referring now to FIG. 4, presented is a flow diagram of an example method 400 for identifying one or more modifications in services (e.g., services 110A-100C or services 202A-202E) that may have caused an error in a service. The method of FIG. 4 includes steps 402, 404, 406, and 408.

In particular, at step 402, the network analyzer may identify an impacted service that has reported an error. The network analyzer may continuously monitor the performance of the services, for example, the one or more services deployed in the workload environment (see FIG. 1, for example). In particular, the network analyzer may continuously monitor an error log relevant to the services to check if any new error is reported in the error log by any of the services. The error log may be maintained by the services in the IT infrastructure (e.g., the IT infrastructure 108 of FIG. 1) and is accessible to the network analyzer. For example, the error log may be stored in one or more of the servers (e.g., the servers 114A-114C) and is accessible to the network analyzer. The network analyzer may retrieve the error log from the respective servers 114A-114C to check for any issues. In another example, the application that uses the services or the services themselves may be configured to send the error log to the network analyzer.

The error log may include information about the error and a corresponding service that caused the error. In particular, an entry in the error log may contain information about the error (e.g., one or more of an error identifier, error description, an affected feature) and information about the service (e.g., the unique service identifier) that caused this error. Using such information in the error log, the network analyzer may identify the reported error and the service that reported the error. The service that reported the error or a service corresponding to which the error is reported in the error log is referred to as an impacted service.

Once the impacted service is identified, the network analyzer, at step 404, may identify one or more upstream services related to the impacted service. In particular, the network analyzer may access a service dependency database (see Table 2 for example) containing the information about the interdependency between the services to find the upstream services corresponding to the impacted service. As previously noted, the interdependency between the services indicates which services rely on which services. For a given service, the upstream service may be a service to which the given service relies. In the example represented in FIG. 2 (also refer to Table 2), if the impacted service is identified as the service 210 (having service identifier “SERVICE ID5”), the services 204 (having service identifier “SERVICE ID2”) and the service 202 (having service identifier “SERVICE ID1”) may be determined as the upstream services. However, if the impacted service is identified as the service 208 (having service identifier “SERVICE ID4”), the service 202 may be identified as the upstream service.

Furthermore, at step 406, the network analyzer may identify at least one modification in one or more of the impacted service or the one or more upstream services based on respective versions of the impacted service and the one or more upstream services. As will be appreciated, in some examples, the network analyzer maintains a version control log for each service deployed in the workload environment. In some other examples, the version control log for the services hosted in the workload environment may be stored in any of the systems (e.g., servers) in the IT infrastructure of the workload environment, and the network analyzer may have necessary access permissions to access such a version control log. In particular, the network analyzer may access the impacted service's and upstream services' version control information from the version control log (stored locally at the network analyzer or at the workload environment) to identify respective change requests. These change requests may include details about the modifications made in the respective services, such as a code change, a configuration change, a hardware change, an operating environment change, or combinations thereof.

Moreover, at step 408, the network analyzer may report a set of candidate modifications selected from the at least one modification as probable causes of the problem. After at least one modification is identified at step 406, the network analyzer may select the set of candidate modifications based on predefined criteria. For example, the network analyzer may select recent modifications (e.g., modifications made one hour prior to the issue/problem being reported) as the set of candidate modifications. In certain other examples, the network analyzer may filter out certain modifications that are known to be irrelevant to the problem (i.e., based on past user inputs). In one example, the network analyzer may report the set of candidate modifications by way of displaying information about the set of candidate modifications on a display. In some other examples, the network analyzer may electronically communicate a notification containing information about the set of candidate modifications to an authorized user. The notification may be sent using one or more messaging techniques, including but not limited to, displaying an alert message on a display, via a text message such as a short message service (SMS), a Multimedia Messaging Service (MMS), and/or an email, via an audio alarm, video, or an audio-visual alarm, a phone call, etc.

Turning now to FIG. 5, presented is a flow diagram of another example method 500 for identifying one or more modifications in one or more services (e.g., services 110A-100C or services 202A-202E) as probable causes of an error in a service. The method 500 of FIG. 5 may include certain additional steps and or information compared to the method 400 of FIG. 4. Accordingly, certain details of the steps that are already described in FIG. 4 are not repeated herein for the sake of brevity. Also, for illustration purposes, the FIG. 5 references FIG. 2 in certain instances.

At step 502, the network analyzer may monitor service performance data corresponding to a plurality of services hosted in a workload environment (e.g., a cloud platform). The service performance data may include one or more incident logs, error logs, or service health logs. These logs may be maintained as separate files or combined into a single file storing data relevant to the errors and/or issues encountered by the services hosted in the workload environment. In some examples, these service performance data may be stored in one or more of the servers in the workload environment and periodically transmitted to the network analyzer. In some examples, the network analyzer may have necessary access permissions to access such service performance data stored in the one or more servers in the workload environment. Accordingly, the network analyzer may monitor service performance data by accessing such log files stored in the workload environment or stored locally at the network analyzer.

Further, at step 504, the network analyzer may perform a check to determine if an error is encountered by any of the services. For instance, if the network analyzer identifies any entry in the service performance data that indicates an error or issue (e.g., by way of listing an error identifier, any performance degradation, etc.), the network analyzer is said to have detected the error. However, if the network analyzer does not identify any entry indicating an error, the network analyzer is said to have not detected the error. If no error is detected, the network analyzer may continue monitoring the service performance data at step 502.

However, on detecting the problem, the network analyzer, at step 506, may identify an impacted service that has reported the error. In particular, an entry in the service performance data (e.g., in an error log) may contain information about the error (e.g., one or more of an error identifier, error description, an affected feature) and information about a service (e.g., the unique service identifier) that caused this error. Using the error log, the network analyzer may identify the service corresponding to which the error is reported, and such service is referred to as the impacted service.

After the impacted service is identified, the network analyzer, at step 508, may retrieve inter-service dependency data corresponding to the impacted service. In particular, the network analyzer may access the service dependency database that stores the inter-service dependency data for several services. Further, at step 510, the network analyzer may identify one or more upstream services related to the impacted service. The network analyzer may look for the impacted service (e.g., by way of searching the impacted service's service ID) in the service dependency database to find the services that it relates to, especially the services that it references/uses (i.e., by way of using the services, using their outcomes, or by using any portions of the source codes of such services). In the example represented in FIG. 2 (also refer to Table 2), if the impacted service is identified as the service 210, the network analyzer may search for the service identifier-“SERVICE ID5” in the service dependency database (see Table 2). Accordingly, the network analyzer may identify the services 204 and the service 202 as the upstream services for the service 210.

Further, at step 512, the network analyzer may identify modifications made in one or more of the impacted service or the respective upstream services. To identify the modifications made to the services, the network analyzer may access the impacted service's and the upstream services' version control information from the respective version control log (stored locally at the network analyzer or the workload environment) to identify respective change requests. These change requests may indicate any modifications made for the respective services, such as a code change, a configuration change, a hardware change, an operating environment change, or combinations thereof.

Furthermore, at step 514, the network analyzer may select one or more candidate modifications from the modifications (identified at step 512). In some examples, the network analyzer may select one or more candidate modifications based on the timestamps associated with the modifications. For instance, the network analyzer may select recent modifications (e.g., modifications made within a predefined duration from the time the error was reported) as the candidate modifications. For such a selection, the network analyzer may apply time-based filtering to discard certain old modifications as the newest/recent modifications may have a more recent impact on the services. The predefined duration for which the modifications are selected may be a customizable parameter and the network analyzer may enable (e.g., by way of providing a user interface) a user to input the predefined duration. In certain other examples, the network analyzer may filter out certain modifications that are known to be irrelevant to the problem (i.e., based on past user inputs).

Further, the network analyzer, at step 516, may assign a weight to each relationship link between the services. As depicted in FIG. 2, the arrows between the two services represent a relationship link between the two services. In certain examples, the service dependency database may also store the details about the relationship links and the respective weights assigned to each of the relationship links. Table 3 presented below depicts another example content of the service dependency database maintained by the network analyzer.

TABLE 3
Example service dependency database

| | SERVICE ID OF | | WEIGHT OF |
|---|---|---|---|
| | AN UPSTREAM | RELATION- | THE RELATION- |
| SERVICE ID | SERVICE | SHIP LINK | SHIP LINK |
| SERVICE ID1 | | | |
| SERVICE ID2 | SERVICE ID1 | 212A | W_{A} |
| SERVICE ID3 | SERVICE ID2 | 212B | W_{B} |
| SERVICE ID4 | SERVICE ID1 | 212C | W_{C} |
| SERVICE ID5 | SERVICE ID2 | 212D | W_{D} |

In some examples, the network analyzer may assign the same weights to all relationship links (i.e., W_{A}=W_{B}=W_{C}=W_{D}). In some examples, the network analyzer may assign unequal weights to the relationship links. Further, in some examples, the weights assigned to the relationship links may be any value in a range from 0 (zero) to 1 (one), and that may be dynamically updated by the network analyzer and/or customizable by the user via a user interface.

After the weights are assigned, the network analyzer, at step 518, may calculate a relevancy score for each candidate modification based on the weights assigned to the relationship links. The relevancy score for a given modification may be determined as a function of the weights corresponding to all relationship links between a service in which the given modification is made and the impacted service. By way of example, the relevancy score (RCₘ) for a given modification (m) may be determined as a product of weights corresponding to all of the relationship links between the service in which the given modification (m) is made and the impacted service, see Equation (1) represented below.

$$R {C}_{m} = {\prod }_{i = 1}^{N} Wi \qquad Equation ( 1 )$$

where, N represents the count of relationship links between the service in which the given modification (m) is made and the impacted service. Further, Wᵢ represents the weight of a relationship link (i).

In the given example, where the impacted service is identified as the service 210, and the corresponding upstream services are services 204 and 202, for a modification m1 made in the upstream service 202, there exist two relationship links (i.e., N=2) between the service 202 (i.e., the service in which the candidate modification was mode) and the impacted service 210 (i.e., the service that encountered an error), and such relationship links are—relationship links 212A (i=1) and 212D (i=2). Accordingly, the weight of the relationship link 212A may be Wᵢ₌₁=W_{A}, and the weight of the relationship link 212D may be Wᵢ₌₂=W_{D} (see Table 3). Accordingly, the relevancy score for the modification m1 may be represented as follows using equation (2), for example.

$$R {C}_{m 1} = {W}_{A} * {W}_{D} \qquad Equation ( 2 )$$

Similarly, the network analyzer may determine the relevancy scores of each of all candidate modifications (selected at step 514). By way of example, for an error identified in the service 210 (i.e., the impacted service), if the candidate modifications are identified as m1and m2 made respectively in services 202 and 204, the respective relevancy scores are presented in Table 4 presented below.

TABLE 4
Relevancy scores of example candidate modifications

| CANDIDATE | | | |
|---|---|---|---|
| MODIFI- | | RELATIONSHIP | RELEVANCY |
| CATION | SERVICE | LINKS | SCORE |
| m1 | SERVICE 202 | 212A, 212D | RCₘ₁ = W_{A} * W_{D} |
| m2 | SERVICE 204 | 212D | RCₘ₂ = W_{D} |

By way of example, if W_{A}=W_{B}=W_{C}=W_{D}=0.5, then the RCₘ₁ and RCₘ₂ may respectively be determined as 0.25 and 0.5 using the example relationship of Equation (1). Further, in some examples, although not depicted in Table 4, the network analyzer may be configured to assign a default relevancy score (e.g., 1) to any candidate modification made in the impacted service itself. In some examples, such default relevancy score may be greater than the relevancy score assigned to any of the candidate modifications made in the upstream services related to the impacted service. In particular, the value of the relevancy score may indicate the impact of the respective modification on the error encountered by the impacted service. With the above-described example technique of calculating the relevancy score, a higher value of the relevancy score indicates a higher impact on the error encountered by the impacted service. Accordingly, the modification m2 may have a greater impact on the error caused in the service 210 than the modification m1. If a candidate modification m3 (not shown in Table 3) is identified in the impacted service, the network analyzer may assign a default relevancy score of 1 to the candidate service indicating the candidate modification m3 may have a higher impact on the error encountered by the impacted service compared to the impacts caused by any of the candidate modifications m1 or m2.

It may be noted that although only two candidate modifications-m1 and m2, are listed in Table 4, in a production implementation, the network analyzer may identify greater or fewer candidate modifications for any problem/error encountered by the impacted service. After the relevancy scores are determined, the network analyzer, at step 520, may report a set of candidate modifications as probable causes of the problem/error encountered by the impacted service. In some examples, the list of the candidate modifications may also include the relevancy scores corresponding to each candidate modification to provide the user an idea about the impact of each candidate modification on the error. In certain other examples, the network analyzer may first rank-order (e.g., in descending order of the relevancy scores) the candidate modifications according to respective relevancy scores and then report such ordered list at step 520.

After the candidate modifications are reported, a user may take necessary actions to address the error by making any corrections in the impacted service and/or the related upstream service. This way, the user may also verify which one or more of the candidate modifications have caused the error in the impacted service. In some examples, the network analyzer may also enable a user interface that allows the user to provide input to specify the candidate modification(s) that caused the error (i.e., modifications that are the root causes of the error). In certain other examples, the network analyzer may monitor the user actions (e.g., debug efforts, corrections/edits made to the services, etc.) taken responsive to the reporting and identify which modification(s) are the root causes of the error. Responsive to receiving such inputs on the correctness of a given modification being a root cause or responsive to determining the root cause based on monitoring of the user actions, in some examples, the network analyzer may update the weights of immediate relationship links. For example, if it is confirmed that the modification m1 is the root cause of the error, the network analyzer may increase the weight W_{A} by a predetermined amount (e.g., increase W_{A} to 0.6 from 0.5). Such a dynamic adjustment of the weights may increase the accuracy of future identifications of the candidate modifications.

Terms and phrases used in this document, and variations thereof, unless otherwise expressly stated, should be construed as open-ended as opposed to limiting. As examples of the foregoing, the term “including” should be read as meaning “including, without limitation” or the like. The term “example” is used to provide exemplary instances of the item in the discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent. Further, the term “and/or” as used herein refers to and encompasses any and all possible combinations of the associated listed items. It will also be understood that, although the terms first, second, third, etc., may be used herein to describe various elements, these elements should not be limited by these terms, as these terms are only used to distinguish one element from another unless stated otherwise or the context indicates otherwise.

The foregoing detailed description refers to the accompanying drawings. It is to be expressly understood that the drawings are for illustration and description only. While several examples are described in this document, modifications, adaptations, and other implementations are possible. Accordingly, the following detailed description does not limit disclosed examples. Instead, the proper scope of the disclosed examples may be defined by the appended claims.

The terminology used herein is for the purpose of describing particular examples and is not intended to be limiting. As used herein, the singular forms “a,” “an,” and “the” are intended to include the plural forms as well, unless the context clearly indicates otherwise. The term “another,” as used herein, is defined as at least a second or more. The term “coupled,” as used herein, is defined as connected, whether directly without any intervening elements or indirectly with at least one intervening element, unless indicated otherwise. For example, two elements can be coupled mechanically, electrically, or communicatively linked through a communication channel, pathway, network, or system. Further, the term “and/or” as used herein refers to and encompasses any and all possible combinations of the associated listed items. It will also be understood that, although the terms first, second, third, etc., may be used herein to describe various elements, these elements should not be limited by these terms, as these terms are only used to distinguish one element from another unless stated otherwise or the context indicates otherwise. The term “based on” means based at least in part on.

While certain implementations have been shown and described above, various changes in form and details may be made. For example, some features and/or functions that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described.

In the foregoing description, numerous details are set forth to provide an understanding of the subject matter disclosed herein. However, an implementation may be practiced without some or all of these details. Other implementations may include modifications, combinations, and variations from the details discussed above. It is intended that the following claims cover such modifications and variations.

What is claimed is:

1. A method comprising:
identifying, by a network analyzer, an impacted service reporting an error;
identifying, by the network analyzer, one or more upstream services related to the impacted service based on a service dependency between the one or more upstream services and the impacted service;
identifying, by the network analyzer, at least one modification in one or more of the impacted service or the one or more upstream services based on respective versions of the impacted service and the one or more upstream services; and
reporting, by the network analyzer, a set of candidate modifications selected from the at least one modification as probable causes of the error.

2. The method of claim 1, wherein the at least one modification comprises a code change, a configuration change, a hardware change, an operating environment change, or combinations thereof.

3. The method of claim 1, further comprising identifying, by the network analyzer, the error based on service performance data corresponding to a plurality of services.

4. The method of claim 3, wherein the service performance data comprises information from one or more of incident logs, error logs, or service health logs.

5. The method of claim 4, wherein each entry in one or more of the incident logs, error logs, or device health logs comprises a unique identifier associated with a service relating to the entry, and wherein identifying the impacted service comprises identifying the unique identifier corresponding to impacted service reporting the error based on one more of the incident logs, error logs, or device health logs.

6. The method of claim 1, further comprising selecting, by the network analyzer, one or more candidate modifications from the at least one modification based on a timestamp associated with the at least one modification.

7. The method of claim 6, further comprising:
assigning, by the network analyzer, a weight to each relationship link between the impacted service and the one or more upstream services related to the impacted service;
determining, by the network analyzer, a relevancy score for each candidate modification of the set of candidate modifications based on the weights assigned to the one or more relationship links; and
rank-ordering, by the network analyzer, the set of candidate modifications based on the relevancy score for each candidate modification.

8. The method of claim 7, wherein the relevancy score for a given candidate modification is determined as a product of the weights of each relationship link between the impacted service and a service in which the given candidate modification is made.

9. A network analyzer comprising:
a non-transitory machine-readable storage medium storing instructions; and
a processing resource coupled to the non-transitory machine-readable storage medium and configured to execute one or more of the instructions to:
identify an impacted service reporting an error;
identify one or more upstream services related to the impacted service based on a service dependency between the one or more upstream services and the impacted service;
identify at least one modification in one or more of the impacted service or the one or more upstream services based on respective versions of the impacted service and the one or more upstream services; and
report a set of candidate modifications selected from the at least one modification as probable causes of the error.

10. The network analyzer of claim 9, wherein the processing resource is configured to execute one or more of the instructions to identify the error based on service performance data corresponding to a plurality of services hosted on a cloud platform.

11. The network analyzer of claim 10, wherein the service performance data comprises information from one or more of incident logs, error logs, or device health logs, wherein each entry in one or more of the incident logs, error logs, or device health logs comprises a unique identifier associated with a service relating to the entry, and wherein identifying the impacted service comprises identifying the unique identifier corresponding to impacted service based on one more of the incident logs, error logs, or device health logs.

12. The network analyzer of claim 9, wherein non-transitory machine-readable storage medium is configured to store a service dependency database comprising information representing relationships between a plurality of services, and wherein the processing resource is configured to execute one or more of the instructions to determine the one or more upstream services based on the relationships between a plurality of services stored in the service dependency database.

13. The network analyzer of claim 9, wherein the processing resource is configured to execute one or more of the instructions to select one or more candidate modifications from the at least one modification based on a timestamp associated with the at least one modification.

14. The network analyzer of claim 13, wherein the processing resource is configured to execute one or more of the instructions to:
assign a weight to each relationship link between the impacted service and the one or more upstream services related to the impacted service;
determine a relevancy score for each candidate modification of the set of candidate modifications based on the weights assigned to the one or more relationship links; and
rank-order the set of candidate modifications based on the relevancy score for each candidate modification.

15. The network analyzer of claim 14, wherein a value of the weight is in a range from 0 (zero) to 1 (one).

16. A non-transitory machine-readable storage medium comprising instructions executed by a processing resource, wherein the instructions comprise:
instructions to identify an impacted service reporting an error;
instructions to identify one or more upstream services related to the impacted service based on a service dependency between the one or more upstream services and the impacted service;
instructions to identify at least one modification in one or more of the impacted service or the one or more upstream services based on respective versions of the impacted service and the one or more upstream services; and
instructions to report a set of candidate modifications selected from the at least one modification as probable causes of the error.

17. The non-transitory machine-readable storage medium of claim 16, wherein the instructions further comprise instructions to select the set of candidate modifications from the at least one modification based on a timestamp associated with the at least one modification.

18. The non-transitory machine-readable storage medium of claim 16, wherein the instructions further comprise instructions to:
assign a weight to each relationship link between the impacted service and the one or more upstream services related to the impacted service; and
determine a relevancy score for each candidate modification of the set of candidate modifications based on the weights assigned to the one or more relationship links.

19. The non-transitory machine-readable storage medium of claim 18, wherein the instructions further comprise instructions to determine the relevancy score for a given candidate modification by calculating a product of the weights of each relationship link between the impacted service and a service in which the given candidate modification is made.

20. The non-transitory machine-readable storage medium of claim 18, wherein the instructions further comprise instructions to rank-order the set of candidate modifications in descending order of the respective relevancy score.
